(19) United States
(12) Patent Application Publication
(10) Pub. No.: US 2010/0112325 A1
(43) Pub. Date: May 6, 2010

(54) SPLITTABLE CONJUGATE FIBER, FIBER STRUCTURE USING THE SAME AND WIPING CLOTH

(76) Inventors: Hayato Iwamoto, Fukuoka (JP); Shinji Yoshida, Fukui (JP); Satoshi Kishi, Fukui (JP); Toru Ito, Osaka (JP)

Correspondence Address: Kirschstein, Israel, Schiffmiller & Pieroni, P.C., 425 FIFTH AVENUE, 5TH FLOOR, NEW YORK, NY, 10016-2223, US

(21) Appl. No.: 12/595,873

(22) PCT Filed: Apr. 17, 2008
(86) PCT No.: PCT/JP2008/057548

§ 371 Date: Oct. 14, 2009

(30) Foreign Application Priority Data
Apr. 18, 2007 (JP) 2007-109928
Apr. 18, 2007 (JP) 2007-109929
Apr. 18, 2007 (JP) 2007-109931
May 9, 2007 (JP) 2007-125078
May 9, 2007 (JP) 2007-125079

(51) Int. Cl. B32B 5/02; B65B 7/00; D02G 3/04; D02G 3/02; D01F 6/00

(52) U.S. Cl. 428/221; 156/69; 428/373; 57/244; 57/255; 19/66 R

(57) ABSTRACT

A splittable conjugate fiber for obtaining a fiber structure excellent in denseness and bulkiness includes a polyamide resin composition and a fiber-forming polymer not having an affinity with the polyamide resin composition. The polyamide resin composition and the fiber-forming polymer are combined with each other in a fiber longitudinal direction. The polyamide resin composition contains aromatic polyamide and aliphatic polyamide. Preferably, the aromatic polyamide is a nylon MXD6 polymer, and the aliphatic polyamide is a nylon 6 polymer.

### TECHNICAL FIELD

The present invention relates to a splittable conjugated fiber comprising polyamide and a fiber-forming polymer, such as polyester, which does not have an affinity with polyamide and a fiber structure using the same and a wiping cloth.

### BACKGROUND ART

A splittable conjugate fiber is a conjugate fiber obtained by conjugate spinning two or more polymers, and is used for various applications in the form of a fiber structure obtained by, for example, forming a fabric and splitting a conjugate fiber.

In particular, a splittable conjugate fiber comprising polyester and polyimide can easily provide a fiber structure excellent in bulkiness and flexibility, and thus is suitably used for various applications, such as clothing (suede fabric and the like) and materials (e.g., wiping cloth and the like). As a wiping cloth, the splittable conjugate fiber is suitably used for cleaning noble metals and cellular phones, polishing and cleaning precision electronic components, such as magnetic recording media (e.g., a hard disk), etc.

Such a splittable conjugate fiber comprising polyester and polyamide can be usually split into the components by physical treatment or chemical treatment. In order to obtain a high-density fabric using general polyamide, a splittable conjugate fiber is formed into a fabric, and the splittable conjugate fiber is split by swelling and shrinking polyamide using a swelling agent and a shrinking agent, such as benzyl alcohol, to form a high-density fabric, whereby a dense fiber structure excellent in bulkiness is obtained as described in Patent Documents 1 to 3.

Recently, the capacity of a hard disk has been advanced and products of 100 GB or more become general in the use of wiping cloth. Simultaneously, the reduction in the size of a hard disk has been remarkably advanced. Thus, in order to satisfy the increase in the capacity and the reduction in the size, the disc surface needs to be precisely polished.

For such a request, a splittable conjugate fiber comprising polyamide and polyester can be split into the components by physical treatment or chemical treatment; and can provide an inexpensive micro fiber having a property suitable for precise polishing. For example, Patent Document 4 proposes a wiping cloth which is obtained by increasing the density of a textile after splitting a splittable conjugate fiber and which has a specific count and cover factor suitable for polishing a hard disk.

Moreover, Patent Documents 5 to 8 describe a conjugate fiber comprising polyester and a specific polyester. However, Patent Documents 5 to 8 improve dying affinity and nowhere refer to a splittable conjugate fiber.

[Patent-Document 1] JP S53-35633 B

[Patent Document 2] JP S61-37383 B

[Patent Document 3] JP H04-272223 A

[Patent-Document 4] JP 2000-303300 A

[Patent-Document 5] JP H03-161520 A

[Patent Document 6] JP H03-287820 A

[Patent Document 7] JP H03-146715 A

[Patent Document 8] JP H04-281015 A

### DISCLOSURE OF THE INVENTION

### Problems to be Solved by the Invention

However, in the case of splittable conjugate fiber comprising general polyamide and a fiber-forming polymer, such as polyester, which does not have an affinity with polyamide, used for the inventions described in the above-mentioned patent documents, swelling and shrinking of polyamide is limited, which makes it difficult to obtain a dense fiber structure having sufficient splitting properties and excellent bulkiness unless a special treatment agent for swelling and shrinking polyamide, such as benzyl alcohol, is employed.

In the case of fiber splitting with the above-mentioned treatment agent, such as a swelling agent, a shrinking agent, etc., the treatment agent is likely to remain in a fabric after fiber splitting treatment and uneven dying is likely to occur during dying.

When used for wiping precision electronic components, such as magnetic recording media (e.g., a hard disk), no inclusion of impurities has been demanded with the recent increase in demand for preciseness of polishing or the like. Moreover, it has been demanded that self generated particles generated from a fiber material itself of a polishing cloth and a wiping cleaning tool, a low molecular weight material extracted with a solvent, etc., are reduced as much as possible. However, when a fiber is split by, for example, swelling and shrinking using a swelling agent, such as benzyl alcohol, self generated particles originating from an oligomer mainly contained in polyester are deposited on the surface, and the removal of such impurities become difficult. In contrast, when it has been attempted to split a fiber without a swelling agent or the like, sufficient fiber splitting properties are not obtained, resulting in insufficient wiping performance, which is required for polishing and cleaning precision electronic components.

Further, since a swelling agent, such as benzyl alcohol, is expensive and requires waste liquid treatment, the cost of the obtained fiber structure becomes high.

Thus, the present invention aims to solve the above-mentioned problems and obtain a splittable conjugate fiber comprising polyamide and a polymer which does not have an affinity with polyimide for providing a dense fiber structure excellent in bulkiness with low-concentration benzyl alcohol or without a swelling gent, such as benzyl alcohol, when the fabrics of splittable conjugate fiber is split to form a fiber structure.

Another object of the present invention is to provide a fiber structure which is flexible and excellent in bulkiness, and develops a favorable hue without using the above-mentioned treatment agent.

Still another object of the present invention is to provide a wiping cloth for use in, for example, polishing and cleaning precision electronic components in which self generated particles and low molecular weight materials extracted with a solvent are less likely to generate.

### Means for Solving the Problems

In order to achieve the above-mentioned objects, the present invention provides a splittable conjugate fiber comprising a polyamide resin composition and a fiber-forming polymer which does not have an affinity with the polyamide resin composition combined each other in the fiber longitudinal direction, in which the polyamide resin composition contains aromatic polyamide and aliphatic polyamide.

In particular, a splittable conjugate fiber is preferable in which the fiber-forming polymer which does not have an affinity with a polyamide resin composition is polyester resin. Mentioned as another preferable aspect is a splittable conjugate fiber in which the fiber-forming polymer not having an affinity with a polyamide resin composition is polyolefin resin.

As the above-mentioned aromatic polyamide, polyamide is preferable which contains aliphatic dicarboxylic acid and aromatic diamine as a main structural unit. In particular, it is preferable that the aromatic polyamide is poly(metaxylylene adiparaide) and the aliphatic polyamide is a Nylon 6 polymer. The weight ratio of the poly(metaxylylene adipamide) to the Nylon 6 polymer is preferably 35:65 to 70:30. Moreover, for use in wiping precision electronic components, such as magnetic recording media (e.g., a hard disk), a substance containing no inorganic particles is more preferable.

The present invention refers to a fiber structure containing the above-described splittable conjugate fiber, and the above-described fiber structure may be a woven material or knitted material. The present invention also refers to a wiping cloth comprising the above-described fiber structure.

The present invention also refers to a method of producing a fiber structure: including Step (1) of producing a fiber structure using the above-described splittable conjugate fiber, and Step (2-1) of subjecting the fiber structure obtained in Step (1) above to hot water treatment to split the splittable conjugate fiber.

The present invention also refers to a method of producing a fiber structure: including Step (1) of producing a fiber structure using the above-mentioned splittable conjugate fiber, and Step (2-2) of subjecting the fiber structure obtained in Step (1) above to alkali dissolution treatment to split the splittable conjugate fiber.

It is preferable that the methods of producing a fiber structure include Step (8) of heating the obtained fiber structure.

The present invention also refers to a method of producing a wiping cloth: including Step (4) of washing the fiber structure obtained by the above-described production method with pure water; and Step (5) of hermetically sealing a container formed of resin film containing the washed fiber structure.

### EFFECT OF THE INVENTION

With the splittable conjugate fiber of the present invention, a dense fiber structure having a high shrinkage performance and high density can be obtained by splitting a fiber without using a swelling agent. A fabric produced using the splittable conjugate fiber of the present invention can develop a clear hue when dyed. Moreover, when the splittable conjugate fiber of the present invention is used as a wiping cloth for polishing or cleaning precision electronic components, the amount of self generated particles can be reduced while maintaining an outstanding wiping performance.

In addition, in the case of the splittable conjugate fiber of the present invention, a splittable conjugate fiber containing polyester and polyamide also can be split with using low-concentration benzyl alcohol or without a swelling agent, such as benzyl alcohol, whereby a bulky and flexible fiber structure can be provided at low cost.

More specifically, since the splittable conjugate fiber of the present invention comprises a polyamide resin composition containing aromatic polyamide and aliphatic polyamide as a polyamide component, the shrinkage performance of the polyimide component is high. According to conventional benzyl alcohol treatment, a splittable conjugate fiber is split into a plurality of components by swelling and shrinking polyamide. However, since the splittable conjugate fiber of the present invention comprises a polyamide component with a high shrinkage performance, the splittable conjugate fiber of the present invention is imparted with a high shrinkage performance and is easily split. Therefore, the splittable conjugate fiber of the present invention shows favorable fiber splitting properties even when treated with low-concentration benzyl alcohol or a treatment agent, other than benzyl alcohol, having no swelling action or subjected to hot water treatment. A fiber structure to be obtained is excellent in denseness and bulkiness, and is imparted with favorable texture. Furthermore, when a fiber after split is an ultra micro fiber, a fiber product becomes more flexible and dense. In particular, such an effect is notably demonstrated when aromatic polyamide is poly(metaxylylene adipamide) (hereinafter sometimes referred to as Nylon MXD6 polymer).

Moreover, a fiber structure using the splittable conjugate fiber of the present invention has a favorable hue. When a fiber structure using a general splittable conjugate fiber comprising two or more components is dyed, it is difficult to completely match the hue of each component, resulting in somber hue. In contrast, in a fiber structure using a fiber of the present invention, a polyamide component is considerably shrunk, and thus is not exposed to the surface layer. Therefore, the polyamide component cannot be seen from the surface layer of a fiber structure and the surface layer is covered only with another component, which makes it possible to obtain a fiber structure showing a clear hue.

Even when the splittable conjugate fiber of the present invention comprises polyester resin as a fiber-forming polymer which does not have an affinity with a polyamide resin composition, the splittable conjugate fiber of the present invention can be split by partially dissolving a polyester component in weight-reduction processing with an aqueous alkaline solution, which is generally carried out in a general processing step. Since an excellent shrinkage performance is demonstrated by heating a polyamide component by a heated aqueous alkaline solution, fiber splitting properties become excellent. Moreover, self-generated particles and low molecular weight materials originating from an oligomer or the like mainly contained in polyester are removed by dissolution with an aqueous alkaline solution. Therefore, the number of self-generated particles can be reduced, when the splittable conjugate fiber of the present invention is formed into a product.

Furthermore, since the splittable conjugate fiber of the present invention comprises a polyamide resin composition of aromatic polyamide and aliphatic polyamide as a polyamide component, a shrinkage performance of the polyamide component is high. According to conventional benzyl alcohol treatment, a splittable conjugate fiber is split into a plurality of components by swelling and shrinking polyamide. In contrast, since the splittable conjugate fiber of the present invention contains a polyamide component with a high shrinkage performance, a sufficient shrinkage performance can be achieved under heating conditions of weight-reduction processing with an aqueous alkaline solution, which is generally carried out in a general processing step and heating conditions of subsequent heating treatment, which is performed as required. A fiber structure to be obtained is excellent in denseness and bulkiness, and has a wiping performance suitable for polishing a hard disk. Also when precision instruments, such as a hard disk, are polished, a polishing target is not damaged, and possibilities of soiling a polishing target with self-generated particles can be reduced because self-generated particles and low molecular weight materials originating from an oligomer or the like are removed by dissolution with an aqueous alkaline solution.

It should be noted that particularly in the case where the above-mentioned aromatic polyamide is Nylon MXD6 polymer, the above-described effects of the present invention are remarkably demonstrated.

### BRIEF DESCRIPTION OF DRAWINGS

FIG. 1 shows an example of a horizontal cross sectional view of a fiber of a splittable conjugate fiber of the present invention (side by side).

FIG. 2 shows an example of a horizontal cross sectional view of a fiber of a splittable conjugate fiber of the present invention (side by side repetition type).

FIG. 3 shows an example of a horizontal cross sectional view of a fiber of a splittable conjugate fiber of the present invention (radial type).

FIG. 4 shows an example of a horizontal cross sectional view of a fiber of a splittable conjugate fiber of the present invention (radial type).

FIG. 5 shows an example of a horizontal cross sectional view of a fiber of a splittable conjugate fiber of the present invention (hollow annular type).

### BRIEF DESCRIPTION OF NUMERALS

1: Polyamide resin composition component
2: Polyester resin component

### BEST MODE FOR CARRYING OUT THE INVENTION

Hereinafter, the present invention will be described in detail.

A splittable conjugate fiber of the present invention comprises a polyamide resin composition and a fiber-forming polymer which does not have an affinity with the polyamide resin composition.

The above-mentioned polyamide resin composition contains aromatic polyamide and aliphatic polyamide. Since the polyamide resin composition containing such a combination has a high shrinkage performance, favorable fiber splitting properties are demonstrated even in the case of low-concentration benzyl alcohol or a treatment agent, other than alcohol, having no swelling action (e.g., alkali dissolution treatment, hot water treatment). In contrast, in the case where the polyamide component consist of only aromatic polyamide or only aliphatic polyamide, a shrinkage performance is low, resulting in a fiber structure having poor texture. Such a fiber structure is also inferior in wiping performance. Furthermore, since the shrinkage performance of the polyamide resin composition is high, high shrinking is achieved. In contrast, when used in combination with polyester resin or polyolefin resin whose shrinkage performance is not so high as the polyamide resin composition, denseness can be achieved due to the high shrinkage properties and also bulkiness can be achieved.

As the above-mentioned aliphatic polyamide, known fiber-forming polyamide is mentioned, and, specifically, Nylon 6, Nylon 66, Nylon 4, etc., are mentioned. There is no limitation on the molecular weight of the aliphatic polyamide insofar as fiber formation is allowed. Nylon 6 is mass-produced, and thus is advantageous in terms of cost. Therefore, Nylon 6 is preferably used in the present invention.

There is no limitation on polyamide used for the above-mentioned polyamide resin composition insofar as the polyamide has an appropriate relative viscosity in terms of stable operation properties of melt spinning. For example, it is preferable that polyamide have a relative viscosity of 1.8 or more. The relative viscosity thereof is more preferably 2.2 or more, and particularly preferably 2.5 or more. Moreover, the upper limit of relative viscosity up to 3.5 is sufficient in terms of stable operation properties of melt spinning. It should be noted that the above-mentioned relative viscosity is a value at 25° C. which has been measured using 95.8% concentrated sulfuric acid as a solvent.

In order to obtain the effect of the present invention, it is preferable that the above-mentioned aromatic polyamide be polyamide containing aliphatic dicarboxylic acid and aromatic diamine as a main structural unit, Since the shrinkage performance of such aromatic polyamide becomes higher, a fiber structure obtained after fiber splitting treatment is excellent in denseness and bulkiness and is imparted with favorable texture. Moreover, when used as a wiping cloth, a favorable wiping performance can be obtained.

As the above-mentioned aromatic polyamide, Nylon MXD6, i.e., poly(metaxylylene adipamide), is optimal for obtaining the effect of the present invention. Poly(metaxylylene adipamide) is a compound represented by General Formula (1).

H—[NHCH₂[C₆H₄]CH₂NHCOC₄H₈CO]n-OH (1)

The compound is a crystalline thermoplastic polymer obtained from meta xylenediamine and adipic acid. The above-mentioned poly(metaxylylene adipamide) is particularly preferable because shrinkage properties are favorable when mixed with aliphatic polyamide to form a polyamide resin composition.

As the polyamide resin composition of the present invention, it is particularly preferable that aromatic polyamide is poly(metaxylylene adipamide) (Nylon MXD6 polymer) and aliphatic polyamide is Nylon 6. Such a polyamide resin composition has a particularly high shrinkage performance, a fiber structure obtained after fiber splitting treatment is excellent in denseness and bulkiness and is imparted with favorable texture. When used as a wiping cloth, a favorable wiping performance can be obtained. Moreover, in such a case, the mixing weight ratio of Nylon MXD6 polymer to Nylon 6 is more preferably 35:65 to 70:30, and particularly preferably 45:55 to 55:45. It should be noted that Nylon MXD6 polymer is crystalline thermoplastic polyamide obtained through polymerization reaction of metaxylenediamine and adipic acid.

Although Nylon 6 is mentioned as a suitable aliphatic polyamide to be combined with Nylon MXD6 polymer, excellent shrinkage properties can be achieved by another polyamide, such as Nylon 66. Also in such a case, the mixing weight ratio is preferably within the above-mentioned range.

As the above-mentioned aromatic polyamide and aliphatic polyamide, it is preferable that the viscosity of the aliphatic polyamide is higher. Although the reasons are unknown, more excellent shrinkage performance can be obtained by the use of aliphatic polyamide having a higher viscosity. More specifically, it is preferable that a difference in the relative viscosities at 25° C. which have been measured using 95.8% concentrated sulfuric acid as a solvent is not less than 0.2 and not more than 0.4 and that the aliphatic polyamide have high viscosity.

As the fiber-forming polymer which does not have an affinity with a polyamide resin composition, polyester resin or polyolefin resin is mentioned.

In the case where a polymer to be combined with a polyamide resin composition is polyester resin, fiber splitting occurs due to partially dissolution of polyester when alkali dissolution processing is performed. When heated by such an alkali dissolution processing step or heat treatment performed separately, a polyamide resin composition is shrunk to thereby form a high-density and bulky textile. Thus, a sufficient shrinkage performance and fiber splitting performance can be obtained. When such a textile is used as a wiping cloth, an outstanding wiping performance can be achieved. Then, self-generated particles and low molecular weight materials originating from an oligomer or the like mainly contained in polyester are removed by dissolution with an aqueous alkaline solution, the number of self-generated particles in a product using the same can be reduced.

Furthermore, there is an advantage that fiber splitting can be performed without treatment using benzyl alcohol. More specifically, the conjugate fiber of the present invention can be efficiently split because the shrinkage performance of a polyamide component is high. Therefore, the conjugate fiber of the present invention also has an advantage that favorable fiber splitting properties can be obtained without benzyl alcohol treatment, which is performed in general fiber splitting.

Mentioned as the above-mentioned polyester resin are polyethylene terephthalate, polybutylene terephthalate, polyethyleneoxy benzoate, poly-1,4-dimethylcyclohexane terephthalate, copolyester containing the above-mentioned substances as a main component, etc. Other polymers can also be suitably used. Polyethylene terephthalate is preferable in terms of versatility and fiber physical properties.

As the above-mentioned polyolefin resin, polypropylene and the like can be preferably used. In the case where the above-mentioned resin having no affinity with a polyamide resin composition is polyolefine, fiber splitting can be easily performed due to poor adhesiveness between polyolefine and polyamide.

In contrast, it is preferable that a polymer used for the splittable conjugate fiber of the present invention (i.e., a polyamide resin composition, polyester resin, polyolefin resin) contain an inorganic particle in terms of improving spinning operability. There exist a large number of inorganic particles for improving the spinning operability, and titanium oxide, zinc oxide, magnesium carbonate, silicon oxide, calcium carbonate, alumina, etc. are mentioned. There is no limitation on the inorganic particle to be added insofar as the spinning operability is not adversely affected, and titanium oxide is preferably used from the viewpoint of dispersibility or cost performance. The inorganic particle is added in a proportion of preferably 0.1% by weight to 3.0% by weight, and particularly preferably 0.3% by weight to 1.0% by weight based on the yarn weight.

When the above-mentioned inorganic particle is used, the average particle diameter of powder or particles is preferably 0.01 μm to 10 μm, and particularly preferably 0.05 μm to 2 μm. When the average diameter thereof is within the above-mentioned range, aggregation of particles is difficult to occur. Thus, yarn unevenness is difficult to occur, which makes it possible to obtain stable strength.

However, when used for a wiping cloth for use in polishing and cleaning precision electronic components, such as magnetic recording media (e.g., a hard disk), it is preferable that the above-mentioned inorganic particle be not contained in a splittable conjugate fiber.

A conventional splittable conjugate fiber used for a wiping cloth generally contains, as a raw material, resin which contains inorganic particles, such as white pigments (e.g., titanium dioxide), to no small extent as a delustering agent for use in a widely used polyester fiber or polyamide fiber. When a hard disk is precisely polished and cleaned, the titanium dioxide may damage the surface of a hard disk. In the present invention, in order to avoid such a problem, it is preferable not to use the above-mentioned inorganic particles.

Here, no including the above-mentioned inorganic particle means not intentionally adding the above-mentioned inorganic particles, such as titanium dioxide, at the time of spinning. More specifically, it is not meant that a case where inorganic particles are contained in a slight amount by contamination or the like in production and processing steps is excluded. Even in such a case, it is preferable that the analytical value obtained by a general ash content measuring method be less than 50 ppm in a polymer. Thus, the surface of a hard disk is not damaged at the time of polishing and cleaning a hard disk.

Moreover, known additives, such as a delustering agent, pigment, antistatic agent, antibacterial agent, and far-infrared radiation particles, may be added as required.

The fineness of the splittable conjugate fiber of the present invention is not limited, and can be suitably determined in the range capable of spinning. It is preferable that the total fineness of warps and wefts is 30 to 300 dtex in terms of a shrinkage performance of a fiber which has an influence on a wiping performance of a product. The total fineness of warps and wefts is more preferably 40 to 200 dtex, and particularly preferably 50 to 150 dtex. When the fineness is too small, the shrinkage performance as a yarn becomes insufficient. Thus, it is preferable to adjust the fineness in such a manner that a sufficient shrinkage performance can be achieved.

There is no limitation on the single fiber fineness of the splittable conjugate fiber of the present invention further. In the case of an ultra micro fiber in which at least a part of, and preferably all of components after fiber splitting has/have a fineness of 0.5 dtex or lower, a fiber structure to be obtained becomes more excellent in flexibility and denseness. Such a fiber structure is preferable in terms of a polishing performance and a cleaning performance. The fineness is more preferably 0.3 dtex or lower, and particularly preferably 0.2 dtex or lower.

It is preferable that the above-mentioned splittable conjugate fiber have a breaking strength of 3.50 cN/dtex or more. The breaking strength thereof is more preferably 4.00 cN/dtex or more, and particularly preferably 4.50 cN/dtex or more. Due to high fiber strength, when the splittable conjugate fiber is formed into a woven material, a woven material having high denseness can be produced without yarn breakage.

It is preferable that the above-mentioned splittable conjugate fiber have a breaking elongation of 25 to 55%. The breaking elongation is more preferably 25 to 45%, and particularly preferably 30 to 40%. The operability, such as weaving, becomes excellent when the breaking elongation is within the above-mentioned range.

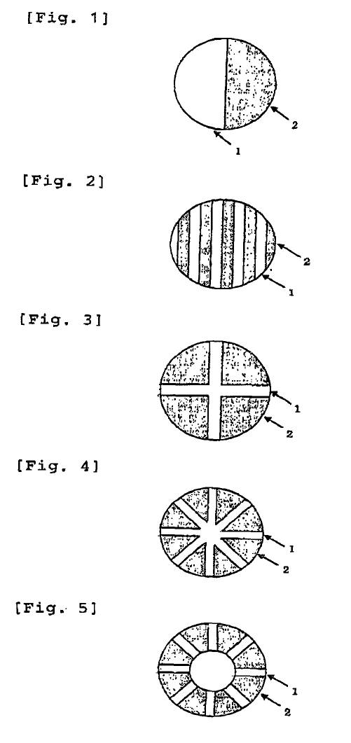

Next, it is preferable that the cross sectional shape of the splittable conjugate fiber of the present invention is in a shape in which the above-mentioned polyamide resin composition and polyester resin is combined to each other along the longitudinal direction of a single fiber while either one of the above-mentioned polyamide resin composition and polyester resin not thoroughly embracing the other component in the horizontal cross section of a single fiber. Specifically mentioned are a side by side splittable conjugate fiber as shown in FIG. 1; a side-by-side repetition splittable conjugate fiber as shown in FIG. 2; radial splittable conjugate fibers as shown in FIGS. 3 and 4 in which the polyamide resin composition and the polyester resin are bonded to each other to have a radial shape (radial section) and a shape complementing the radial section (complementary section); a hollow annular splittable conjugate fiber as shown in FIG. 5; etc.

As a wiping cloth, the radial splittable conjugate fiber and the hollow annular splittable conjugate fiber are preferably used. In particular, in the case of the radial splittable conjugate fiber among splittable conjugate fibers comprising Nylon MXD6 polymer and aliphatic polyamide, and polyester, even when the cross section of a single fiber is divided into a large number of (e.g., 8 or more) complementary sections by radial sections shown in FIG. 4, fiber splitting is effected by alkali dissolution treatment and heat treatment without a swelling agent, such as benzyl alcohol, for shrinking. Thus, impurities of polyester can be removed, there exist few self-generated particles, few remaining ions and non-volatile residue (NVR), and a cleaning performance becomes excellent.

In contrast, as a fiber splitting method of the splittable conjugate fiber of the present invention, a method utilizing alkali dissolution is mentioned. The method involves immersing the splittable conjugate fiber of the present invention in a heated aqueous alkaline solution to partially dissolve polyester and simultaneously shrink a polyamide component to thereby split a fiber. During the process, since self-generated particles and low molecular weight materials originating from an oligomer or the like mainly contained in polyester are removed by dissolution with an aqueous alkaline solution, the number of self-generated particles in a product formed of the splittable conjugate fiber of the present invention can be reduced.

As alkali dissolution treatment conditions, conditions of a method which is generally carried out in weight reduction processing of a polyester textile are mentioned. For example, a method using 0.5% to 5.0% sodium hydroxide can be mentioned. 1.0% to 3.0% sodium hydroxide is more preferable, and 1.0% to 2.0% sodium hydroxide is particularly preferable. The treatment temperature is preferably 85° C. to 100° C., and more preferably 90° C. to its 98° C.

The fiber structure of the present invention refers to a line of thread, yarn bundle, woven material, knitted material, and nonwoven fabric.

As the fiber structure of the present invention, a fiber structure using the entire of or at least a part of, and preferably 20% or more of, the above-mentioned splittable conjugate fiber is mentioned. It is preferable that the fiber structure of the present invention is split after formed into a textile using the above-described splittable conjugate fiber.

When the fiber structure of the present invention is a woven material, a plain weave, satin weave, twill weave, etc., can be mentioned as textile weaves. A satin weave is preferable from the viewpoint that a more dense woven material can be obtained. Moreover, when used as a wiping cloth, a plain weave, satin weave, and twill weave are preferable.

In the fiber structure of the present invention, all fibers forming the fiber structure may be formed of the above-described splittable conjugate fiber or fibers other than the above-described splittable conjugate fiber may be used in a proportion of 30% or lower.

A suitable finishing cover factor of woven material in the case of using, as a wiping cloth to be used in a clean room, the fiber structure of the present invention which is a woven material is mentioned. In the case of a plain weave, it is preferable that the warp is 1000 or more and the weft is 800 or more, and in the case of a satin weave, it is preferable that the warp is 1500 or more and the weft is 1000 or more.

The use of the splittable conjugate fiber of the present invention produces an advantage that a fiber structure having a high cover factor mentioned above can be obtained. More specifically, high shrinkage properties can be achieved by using, as polyamide resin, a polyamide resin composition containing aromatic polyamide and aliphatic polyamide as described above Therefore, the above-mentioned fiber structure is subjected to fiber splitting, and then heat-treated for shrinking the fiber structure, whereby the above-mentioned cover factor can be achieved. When the thus-shrunk fiber structure is a woven and knitted material, the textile is in a state where the surface is formed of polyester and the inside is formed of polyamide.

When the fiber structure of the present invention is a knitted material, any of warp knitting and weft knitting may be acceptable. More specifically, a warp knitted texture is preferable. When used as a wiping cloth, an interlock texture is preferable, for example. In the case where the fiber structure of the present invention, which is a woven material, is used as a wiping cloth to be used in a clean room, it is preferable that the number of wales be 70 to 100 wales/inch and the number of courses be 70 to 100 courses/inch, for example. In the case of a tricot, it is suitable to use about 28G. Moreover, the above-described splittable fiber may be used all of a front yarn, back yarn, and middle yarn or may be used for only a part thereof. It is more preferable to use the above-described splittable fiber for the front and back yarns.

It should be noted that the splittable conjugate fiber may be interwoven and doubled or twisted with a synthetic fiber formed of another single component or may be mixed-weaving or mixed-knitting therewith. Similarly, the splittable conjugate fiber may be mixed-twisting, mixed-weaving, or mixed-knitting with a natural fiber, such as cotton, sheep wool, and silk.

The above-described splittable conjugate fiber is formed in to a fabric, such as a woven and knitted material, and then subjected to fiber splitting to thereby obtain a wiping cloth. The obtained wiping cloth shows an outstanding wiping performance also when used for precision instruments in a clean room, such as use in a production process of a hard disk or the like.

Next, an example of a method of producing the splittable conjugate fiber of the present invention will be specifically described.

First, the above-mentioned aromatic polyamide and the above-mentioned aliphatic polyamide are prepared. Then, the above-mentioned aromatic polyamide and the above-mentioned aliphatic polyamide are mixed to thereby produce a polyamide resin composition. There is no limitation on the mixing method, and, for example, chips thereof can be stirred in a container or kneaded.

Then, the obtained polyamide resin composition and a fiber-forming polymer which does not have an affinity with a polyamide resin compositions, such as the above-mentioned polyester resin, are subjected to spinning. Thus, the resultant was drawn by draw-twisting or the like. There is no limitation on the spinning method and the draw-twisting method. A method of draw-twisting after spinning in a conventional method, a spinning direct drawing method, etc., can be suitably employed. The drawing method is not limited, and a single step drawing, a multi-step drawing, etc., can be suitably employed.

The spinning conditions can be suitably determined in terms of a relative viscosity and operability of a polymer. For example, Nylon 6 polymer having a relative viscosity of 2.0 to 3.0 and Nylon MXD6 polymer having a relative viscosity of around 2.7 are mixed as a polyamide component to thereby produce a polymer resin composition. Subsequently, using polyethylene terephthalate having a limiting viscosity of 0.6 to 0.7 as polyester, melt spinning thereof is carried out by a conventional method to thereby obtain an undrawn yarn. In this case, the extrusion temperature is preferably 280 to 295° C., and particularly preferably 283 to 292° C. Moreover, a spinning winding-up rate is preferably 500 to 2,000 m/min, and particularly preferably 800 to 1,700 m/min.

When polyester is used as a fiber-forming polymer which does not have an affinity with a polyamide resin composition, it is preferable that the limiting viscosity of polyester be 0.4 or more in terms of stable operability of melt spinning. The limiting viscosity of polyester is more preferably 0.5 or more, and particularly preferably 0.6 or more. Moreover, the upper limit of the limiting viscosity is not limited, and a limiting viscosity up to 1.0 is sufficient in terms of stable operability of melt spinning. Moreover, when using polyolefin, it is preferable that a melt mass flow rate (JIS-K7210:99 test method) is preferably 5 g/10 min to 50 g/10 min. The melt mass flow rate is more preferably 10 g/10 min to 30 g/10 min. The moisture contents (ppm) of polyamide for use in a polyamide resin composition and a fiber-forming polymer which does not have an affinity with a polyamide resin composition are not limited, and can be suitably determined. From the viewpoint of spinning operability, it is preferable to use polyamide having a moisture content at the time of spinning of 500 ppm or lower. The moisture content is more preferably 300 ppm or lower, and more preferably 200 ppm or lower. Moreover, in the case of polyester, the moisture content at the time of spinning is preferably 200 ppm or lower, more preferably 100 ppm or lower, and particularly preferably 50 ppm or lower.

There is no limitation on the draw-twisting conditions after wound by a conventional method. A single step drawing, multi-step drawing, roller heater/roller heater drawing, roller heater/plate heater drawing, etc. can be suitably employed.

For example, when an undrawn yarn obtained by melt spinning in the above-mentioned conventional method is subjected to draw-twisting using a roller heater and a plate heater, the roller heater is preferably 60° C. to 90° C., and particularly preferably 70° C. to 85° C. The plate heater is preferably 130° C. to 170° C., and particularly preferably 145° C. to 160° C.

It is preferable to adjust a draw ratio according to a spinning rate. By determining the spinning rate and the draw ratio in such a manner as to have a good balance, the strength and stretchability of the fiber to be obtained can be adjusted to thereby obtain a fiber excellent in weaving properties. For example, when the spinning rate is adjusted to 1,500 m/min., the draw ratio is preferably adjusted to 2.0 times to 2.4 times, and particularly preferably 2.1 times to 2.3 times.

The drawing rate is preferably 500 to 1,000 m/min, and particularly preferably 600 to 900 m/min in terms of operability. Moreover, it is preferable to adjust the number of spindle revolutions (rpm) to a value in accordance with a drawing rate. By suitably determining the number of spindle revolutions in accordance with a drawing rate, a suitable twisting number is achieved, and thus favorable operability and favorable shrinkage performance can be achieved.

The thus-obtained splittable conjugate fiber is formed into a fabric, such as a woven and knitted material and a nonwoven fabric, and subjected to fiber splitting to thereby obtain a fiber structure of the present invention. The above-mentioned splittable conjugate fiber may be split in the state of yarn to thereby obtain a fiber structure as a fabric.

It should be noted that there are various known fiber splitting methods, and a method is well known which involves swelling and shrinking polyamide with an emulsified aqueous solution, such as benzyl alcohol or phenyl ethyl alcohol, to thereby split polyamide and a fiber-forming polymer which does not have an affinity with polyamide or a method is well known which separates both the components by applying physical force, such as twisting.

As a physical fiber splitting method, various methods, such as drawing, twisting, and applying an impact, are mentioned. For example, there is a method involves twisting or heating fiber by false twisting to thereby separate both the components. The polyamide resin composition used in the fiber of the present invention can be efficiently subjected to fiber splitting even by false twisting because the polyamide resin composition is sharply swollen and shrunk by heat.

As another method, a method utilizing alkali dissolution is mentioned. The method is used when polyester resin is used. Such a method utilizing alkali dissolution is particularly preferable when used in a case where the surface of a fiber structure needs to be clean, such as a wiping cloth. A method is mentioned which involves immersing the fiber of the present invention in a heated aqueous alkaline solution to thereby partially dissolve polyester and simultaneously shrink a polyamide component for fiber splitting. It should be noted that the above-mentioned conditions of alkali dissolution treatment are preferable. Moreover, when polyolefin is used, fiber splitting can be performed by only hot water due to poor adhesiveness between polyolefin and polyamide.

Furthermore, the fiber structure using the splittable conjugate fiber of the present invention can be subjected, as required, to known post finishing, such as hydrophilic finishing, anti-electric finishing, water repellent finishing, oil repellent finishing, and soil resistant finishing, etc.

The fiber structure using the splittable conjugate fiber of the present invention is suitable for various intended uses, such as clothing (e.g., general clothing, such as a coat and a blouson, and clothing excellent in fashionability and functionality, such as moisture permeation water proof clothes) and industrial materials, such as various wiping clothes (e.g., an eyeglass wiper), a filter cloth, a tent, and an air bag for automobiles.

Next, a production example of a wiping cloth using the splittable conjugate fiber will be described later.

First, a fiber structure is produced using the above-described splittable conjugate fiber (Step (1)). Step (1) above is not specifically limited and may be a step of producing a fiber structure by a general method.

The fiber structure obtained in Step (1) above is subjected to fiber splitting treatment (Step (2)). It should be noted that it is preferable to use polyester resin as a fiber-forming polymer which does not have an affinity with a polyamide resin composition, and, as the fiber splitting method, a method of performing hot water treatment (Step 2-1) and a method of dissolving in alkali (Step 2-2) are preferably mentioned. In particular, when polyester resin is used as a fiber-forming polymer which does not have an affinity with a polyamide resin composition, the method of dissolving in alkali (Step 2-2) is preferable from the viewpoint that impurities, such as self-generated particles and low molecular weight materials originating from an oligomer contained in polyester resin are likely to be removed by dissolution. When polyolefin resin is used as a fiber-forming polymer which does not have an affinity with a polyamide resin composition, fiber can be appropriately split also by the method of performing hot water treatment.

According to the method of dissolving in an alkali, the splittable conjugate fiber of the present invention is immersed in a heated aqueous alkaline solution to partially dissolve polyester and simultaneously shrink a polyimide component. Thus, since self-generated particles and low Molecular weight materials originating from an oligomer or the like contained in polyester resin are removed by dissolution with an aqueous alkaline solution, the number of self-generated fine particles in a product formed of the splittable conjugate fiber of the present invention can be reduced.

As alkali dissolution treatment conditions, conditions of a method which is generally carried out in weight reduction processing of a polyester fiber structure, and, for example, a method using water solution of 0.5% to 5.0% sodium hydroxide can be mentioned. Water solution of 1.0% to 3.0% sodium hydroxide is more preferable, and 1.0% to 2.0% sodium hydroxide is particularly preferable. The treatment temperature is preferably 85° C. to 100° C., and more preferably 90° C. to its 98° C.

Furthermore, it is preferable to heat the fiber structure obtained in Step (2) above (Step (3)). By such heat treatment, a fiber can be shrunk to thereby increase the density of a fabric. For example, such heat treatment can be performed at 120° C. to 150° C. for about 0.5 to 1 hour under wet heat conditions and can be performed at 150° C. to 190° C. for about 30 seconds to 1 minute under dry heat conditions. The heat treatment in Step (3) above may be performed simultaneously with dying treatment. More specifically, a fiber may be shrunk by heat treatment for dying.

In the method of producing a wiping cloth of the present invention, it is preferable to obtain a final fiber structure by shrinking a woven material by 20 to 40% in the width direction and a knitted material by 40 to 60% in the width direction by subjecting a gray fabric obtained through steps, such as weaving and knitting, to the above-mentioned treatment of each step. Such a shrinkage factor is preferable from the viewpoint that excellent wiping properties are achieved. The shrinkage factor can be calculated by the following calculation formula:

100×{(W0−W)/(W0)}(%)

wherein the width and length of a gray fabric are defined as W0 and L0, respectively and the width and length of a fabric after shrinking are defined as W and L, respectively.

Then, when used for polishing, cleaning, etc., of precision electronic components to be used in a clean room, such as a hard disk, the obtained woven material is subsequently washed with pure water and dried in a clean room, and, as required, the resultant is cut into a desired dimension. Thereafter, the resultant is washed with pure water and dried in a clean room as required to thereby obtain a wiping cloth. It is preferable that the obtained wiping cloth be hermetically sealed in a container formed of a resin film. The hermetically-sealed container is opened at the time of use in a production process of a hard disk or the like, and then the wiping cloth can be used. The above-mentioned wiping cloth can be cut into a desired dimension and shape, such as a string, tape, square, etc.

A fiber structure using the splittable conjugate fiber of the present invention, such as a woven and knitted material, has a raised feeling suitable for polishing or cleaning. Moreover, there are few self-generated fine particles and few low molecular weight materials, and thus precision components are not contaminated. In the case of a fabric for polishing, the above-mentioned fiber structure can be cut into a suitable tape form to thereby obtain a texture tape. The obtained texture tape hardly damages polishing target components.

### EXAMPLES

Hereinafter, the present invention will be described in detail with reference to the following Example. The present invention is not limited to the following Examples.

### A. Measurement of Relative Viscosity and Limiting Viscosity

Measurement of viscosity is performed using an automatic viscometer (SS-600-L1 model) manufactured by Shibayama Scientific Co., Ltd. A relative viscosity is measured in a thermostat having a temperature of 25° C. by dissolving a polymer at a 1 g/dl concentration and using 95.8% concentrated sulfuric acid as a solvent. A limiting viscosity is measured in a thermostat having a temperature of 20° C. using phenol/tetrachloroethane (volume ratio: 6/4) as a solvent.

### B. Measurement of Breaking Strength and Breaking Elongation

Measurement is performed according to JIS-L-1013 using AGS-1KNG autograph tensile tester manufactured by Shimadzu Corp., under conditions of a sample yarn length of 20 cm and a constant tensile rate of 20 cm/min. A value obtained by dividing the maximum vale of load in a load-elongation curve by a fineness is defined as a breaking strength (cN/dtex), and the elongation percentage at that time is defined as a breaking elongation(%).

### C. Calculation of Shrinkage Factor in Boiling Water

A method of calculating shrinkage factor in boiling water is as follows. First, a fiber is turned up, and then a load of 0.2 g is hung from the turned-up position. The fiber is allowed to stand at room temperature for 10 minutes, and the fiber length is then measured. Thereafter, the fiber is immersed in boiling water for 20 minutes. The fiber taken out from boiling water is allowed to stand at room temperature for 10 minutes, and then the fiber length after shrinking is measured. The shrinkage factor in boiling water Δw is calculated by the following equation:

Δw=[(L0−L1)/L0]×100(%)

L0: Fiber length before shrinking under a load of 0.2 g
L1: Fiber length after shrinking under a load of 0.2 g

### Example 1

A polyamide resin composition in which Nylon MXD6 having a relative viscosity of 2.7 and Nylon 6 having a relative viscosity of 3.0 are mixed at a weight ratio of 50:50 is defined as a component A. In contrast, polyethylene terephthalate having a limiting viscosity of 0.61 is defined as a component B.

The component A and the component B were subjected to conjugated melt spinning under conditions of a volume ratio of 1:2, a spinning temperature of 295° C., and a spinning rate of 1500 m/min in such a manner that the component A formed radial sections to thereby obtain an undrawn yarn having the substantially same cross section as that of FIG. 4. During the process, the component A was supplied to a measuring pump via a static mixer after melting. Then, the obtained undrawn yarn was drawn at a drawing rate of 2.50 times using a roller heater having a temperature of 85° C. and a plate heater having a temperature of 150° C. to thereby obtain a splittable conjugate fiber of 110 dtex/50 f.

Then, the drawn yarn was subjected to a cylindrically knitting machine having 28 gauges and a diameter of 10 cm to thereby obtain a cylindrically knitted material. The obtained cylindrically knitted material was immersed in a 2% aqueous sodium hydroxide solution at 95° C. for 80 minutes, and then washed with water, whereby the cylindrically knitted material was split and shrunk. The obtained knitted material had bulkiness and showed favorable texture.

Moreover, in order to analyze a sinking degree of a polyamide component, an L value (brightness) of a cylindrically knitted material in which only the polyamide component was dyed with a deep color using an acid dye was measured, and the amount of polyamide fibers which were visible from the surface was counted. More specifically, when the shrinkage factor of the polyamide component is large, the sinking degree of the polyamide fiber is high and the number of undyed polyethylene terephthalate increases on the surface, resulting in a large L value. Table 1 shows the shrinkage factors and L values of the obtained knitted materials. As is clear from Table 1, a knitted material was considerably shrunk and had bulkiness, and dyed nylon component was hardly observed from the surface layer, and the L value also became large.

### <Evaluation of Operability, Physical Properties, Fiber Splitting Properties According to Differences in a Polyamide Component>

### Examples 2 and 3 and Comparative Examples 1, 2

Fibers were produced following the procedure of Example 1 except changing the weight ratio of Nylon MXD6 to Nylon 6 in a polyamide component, and various evaluation tests were performed.

TABLE 1

| | | Com. Ex. 1 | Ex. 2 | Ex. 1 | Ex. 3 | Com. Ex. 2 |
|---|---|---|---|---|---|---|
| Polyamide component | Nylon MXD6/Nylon 6 (% by weight) | 0/100 | 30/70 | 50/50 | 80/20 | 100/0 |
| Yarn qualities | Strength (cN/dtex) | 4.86 | 4.65 | 4.45 | 4.10 | 4.01 |
| | Breaking elongation (%) | 33.4 | 33.3 | 35.3 | 33.2 | 30.8 |
| | Shrinkage factor in boiling water of | 9.4 | 12.1 | 14.7 | 11.2 | 9.1 |
| | splittable conjugate fiber (%) | | | | | |
| | Shrinkage factor of only a polyamide | 15.2 | 39.3 | 52.7 | 29.0 | 15.3 |
| | component (%) | | | | | |
| Cylindrically | Area shrinkage factor (%) | 31 | 43 | 47 | 42 | 29 |
| knitted material | L value | 67.3 | 77.9 | 78.9 | 77.5 | 65.2 |

In the sample of Comparative Example 1, a polyamide component contains only aliphatic polyamide (Nylon 6). In the sample of Comparative Example 2, a polyamide component contains only aromatic polyamide (Nylon MXD6 polymer). Thus, when the polyamide component contains only a single component, the shrinkage factor was low and the bulkiness of a fiber structure obtained after fiber splitting treatment was also poor. In contrast, as is clear from Table 1, knitted materials using the samples of Examples 1 to 3 according to the present invention were considerably shrunk and had bulkiness. Moreover, the dyed nylon component was hardly observed from the surface layer and the L values also became large.

<Evaluation of Texture after Treatment According to Differences in a Polyamide Component>

Filaments of Examples 1 to 3 and Comparative Examples 1 and 2 were cylindrically knitted, and subjected to alkali dissolution treatment in the same manner as in Example 1. Table 2 shows the results of evaluating the texture of treated samples. It should be noted that the texture was evaluated by sensory evaluation. Then, a sample which was soft and had a bulky feeling was evaluated to have a good texture, and evaluation was performed according to the criteria: “∘” (good) and “x” (poor).

TABLE 2

| | | Com. Ex. 1 | Ex. 2 | Ex. 1 | Ex. 3 | Com. Ex. 2 | Ex. 4 |
|---|---|---|---|---|---|---|---|
| Component A | Nylon MXD6/Nylon 6 (% by weight) | 0/100 | 30/70 | 50/50 | 80/20 | 100/0 | 50/50 |
| Component B | | PET | PET | PET | PET | PET | PP |
| Alkali dissolution treatment | Area shrinkage factor (%) | 31 | 43 | 47 | 42 | 29 | 44 |
| | Texture | x | ∘ | ∘ | ∘ | x | ∘ |
| 5% benzyl alcohol treatment | Area shrinkage factor (%) | 32 | 39 | 44 | 40 | 27 | 42 |
| | Texture | x | ∘ | ∘ | ∘ | x | ∘ |
| Hot water treatment | Area shrinkage factor (%) | 25 | 28 | 30 | 26 | 24 | 40 |
| | Texture | x | x | x | x | x | ∘ |

PET: polyethylene terephthalate
PP: Polypropylene

As a result of evaluating the texture of the samples after subjected to alkali dissolution treatment, the samples of Comparative Examples 1 and 2 were not sufficiently shrunk with alkali dissolution treatment and the texture was poor. In contrast, in Examples 1 to 3 according to the present invention, the samples were sufficiently shrunk with alkali dissolution processing and split, and thus showed favorable texture having a high bulkiness.

Next, 5% benzyl alcohol treatment was performed. The samples were immersed in an emulsified aqueous solution containing 5% by weight of benzyl alcohol and 0.5% by weight of SUNMORL BK-Cone (surfactant, manufactured by NICCA CHEMICAL CO., LTD.) at 25° C. for 3 minutes, subsequently squeezed to pick up 80% thereof, and then allowed to stand for 5 minutes. Thereafter, wet heat treatment was performed for 5 minutes using saturated steam having a temperature of 102° C., and the resultants were washed with water. As a result, the samples of Comparative Examples 1 and 2 were not sufficiently fiber-split and shrunk, resulting in poor texture. In contrast, the samples of Example 1 to 3 according to the present invention showed a sufficient shrinkage performance also with benzyl alcohol having a concentration as low as 5%, and had favorable texture.

<Evaluation of Texture after Treatment According to Differences in Component B>

### Example 4

A fiber was produced following the procedure of Example 1 except using the component B as polypropylene and immersing a sample in hot water of 98° C. for 10 minutes, and various evaluation tests were performed. The results are shown in table 2.

Due to poor adhesiveness between polyolefin and polyamide, the sample was easily fiber-split and shrunk with hot water. Then, a favorable fiber was obtained which had soft texture and bulkiness.

### <Examples of Wiping Performance>

Furthermore, Examples of wiping performance will be described further specifically. The present invention is not limited to the Examples described below.

### A. Limiting Viscosity of Polyester

A limiting viscosity [η] was measured in a usual manner using art automatic viscometer at 20° C. in a mixed solvent of phenol and tetrachloroethane at a weight ratio of 6:4.

B. Relative viscosity of Polyamide

A relative viscosity [ηrel] was measured in a usual manner using an Ostwald viscometer at 20° C. in a sulfuric acid solvent.

### C. Wiping Cloth Performance

Cylindrically knitted materials were produced using a splittable conjugate fiber, and subjected to fiber splitting treatment. Thereafter, an area shrinkage factor (%) of each of the cylindrically knitted materials before and after the treatment was measured. In general, unless the area shrinkage factor (%) is 30% or more, the wiping performance is insufficient.

### D. Number of Self-generated Fine Particles

The number of self-generated particles was measured according to IES-RP-CC003.2 (Helmke drum method) using a particle counter manufactured by RION (KM-27). It should be noted that since the sample used for measurement reduced factors other than self-duct generation, the sample washed with ultrapure water was measured.

### Example 5

A polyamide resin composition in which Nylon MXD6 (manufactured by Mitsubishi Gas Chemical Co., Inc., polyamide MXD6 resin) containing no white pigments, such as titanium dioxide and having a relative viscosity of 2.7 and Nylon 6 containing no white pigments, such as titanium dioxide and having a relative viscosity of 2.6 were mixed at a weight ratio of 50:50 was used as the component A. In contrast, polyethylene terephthalate having a limiting viscosity 0.61 was used as the component B.

The component A and the component B were subjected to conjugated melt spinning under conditions of a volume ratio of 1:2, a spinning temperature of 295° C., and a spinning rate of 1,050 m/min in such a manner that the component A formed radial sections to thereby obtain an undrawn yarn having the substantially same cross section as that of FIG. 4. Then, the obtained undrawn yarn was drawn at a draw ratio of 3.0 times using a roller heater having a temperature of 85° C. and a plate heater having a temperature of 150° C. to thereby obtain a splittable conjugate fiber of 56 dtex/25 f.

Then, the obtained splittable conjugate fiber was subjected to a cylindrically knitting machine having 28 gauges and a diameter of 10 cm to thereby obtain a cylindrically knitted material. The obtained cylindrically knitted material was immersed in a 2% aqueous sodium hydroxide solution at 95° C. for 30 minutes, and then washed with water, whereby the cylindrically knitted material was split and shrunk.

In order to evaluate the wiping performance of the obtained cylindrically knitted material, the area of the cylindrically knitted material before and after the shrinking treatment was measured, and then the area shrinkage factor (%) was calculated. A shrinkage factor as high as 42.6% was obtained.

Moreover, the number of self-generated fine particles with a dimension of 0.3 μm or more on the obtained cylindrically knitted material was measured. The number of the particles was as small as 14 in total.

Moreover, with the obtained cylindrically knitted material, the surface of a hard disk was actually rubbed, and then the damage degree of the surface was confirmed. The surface was hardly damaged.

### Comparative Example 3

A splittable conjugate fiber was produced following the procedure of Example 1 except using, as the component A, only Nylon 6 having a relative viscosity 2.6, and various evaluation tests were performed. The results are shown in table 3.

### Comparative Example 4

A splittable conjugate fiber was produced by the method of Comparative Example 3. A cylindrically knitted material was fiber-split and shrunk when immersed in an aqueous emulsified solution containing 15% by weight of benzyl alcohol and 0.5% by weight of SUNMORL BK-Cone (surfactant, manufactured by NICCA CHEMICAL CO., LTD.) at 40° C. for 10 minutes. Then, various evaluation tests were performed.

The results are shown in table 3.

TABLE 3

| | | | | Com. Ex. |
|---|---|---|---|---|
| | | Ex. 5 | Com. Ex. 3 | 4 |
| Component A | | Nylon 6 + | Nylon 6 | Nylon 6 |
| | | Nylon MXD6 | | |
| Component B | | PET | PET | PET |
| Fiber splitting method | | Alkali | Alkali | Benzyl |
| | | reduction | reduction | alkali |
| | | | | treatment |
| Area shrinkage factor (%) | | 42.6 | 35.3 | 60.5 |
| Number of self- | 0.3 μm< | 7 | 18 | 78 |
| generated particles | 0.5 μm< | 4 | 8 | 62 |
| | 1 μm< | 2 | 2 | 39 |
| | 3 μm< | 1 | 0 | 7 |
| | 5 μm< | 0 | 0 | 1 |
| | 10 μm< | 0 | 0 | 0 |

Next, a glass plate was prepared, and then a given amount of vaseline was applied to the surface of the glass plate. Thereafter, the surface of the glass plate was wiped given times with the obtained cylindrically knitted material. Then, the removal degree of vaseline was observed. With the samples of Example 1 and Comparative Example 2, vaseline was thoroughly removed similarly. However, the sample of Comparative Example 1 was inferior in wiping properties to the sample of Example 1.

### Example 6

A polyamide resin composition in which Nylon MXD6 (manufactured by Mitsubishi Gas Chemical Co., Inc., polyamide MXD6 resin) having a relative viscosity of 2.7 and Nylon 6 having a relative viscosity of 2.6 were mixed at a weight ratio of 50:50 was used as the component A. In contrast, polyethylene terephthalate having a limiting viscosity 0.61 was used as the component B. Used as the components A and B were substances containing no inorganic particles, such as titanium dioxide.

The component A and the component B were subjected to conjugated melt spinning under conditions of a volume ratio of 1:2, a spinning temperature of 295° C., and a spinning rate of 1,050 m/min in such a manner that the component A formed radial sections to thereby obtain an undrawn yarn having the substantially same cross section as that of FIG. 4. Then, the obtained undrawn yarn was drawn at a draw ratio of 3.0 times using a roller heater having a temperature of 85° C. and a plate heater having a temperature of 150° C. to thereby obtain a splittable conjugate fiber of 56 dtex/25 f.

A substance was prepared polyester multifilament of 84 dtex/36 f (S twist: 200 T/m) as warp and multifilament which was obtained by doubling two of the above-obtained splittable conjugate fiber multifilament of 56 dex/25 f and twisting the resultant by 110 T/m in the S direction as warp. The substance was woven into 5 harness satins at a warp density of 140 warps/2.54 cm and a weft density of 91 wefts/2.54 cm, to thereby obtain a gray fabric. The obtained gray fabric was purified, and immersed in a 2% aqueous sodium hydroxide at 95° C. for 30 minutes to thereby split the splittable conjugate fiber. Subsequently, the resultant was subjected to jet dying at 130° C. for 30 minutes to thereby shrink the splittable conjugate fiber. The warp density of the obtained woven material was 192 warps/2.54 cm and the weft density thereof was 95 wefts/2.54 cm. The shrinkage factor in the width direction was 27% and the area shrinkage factor between the gray fabric and the obtained, woven material was 35%.

The obtained fabric was washed with ultrapure water, and then dried in a clean room. The fabric was cut into a desired dimension, and then washed with ultrapure water twice to thereby obtain a wiping cloth for clean rooms.

### Comparative Example 5

A gray fabric was obtained in the same manner as in Example 6 except using, as the component A, only Nylon 6 having a relative viscosity of 2.6. The obtained gray fabric was treated at 95° C. with an emulsified aqueous solution containing 35% by weight of benzyl alcohol and 5% by weight of KM-300 (surfactant, manufactured by TAKEMOTO OIL & FAT Co., Ltd.) after padding to thereby split and shrink the splittable conjugate fiber. The warp density of the obtained fabric was 192 warps/2.54 cm and the weft density thereof was 95 wefts/2.54 cm. Here, the area shrinkage factor between the gray fabric and the obtained fabric was 35%. A wiping cloth was obtained in the same manner as in Example 6 using the obtained woven material.

The area shrinkage factor was calculated by the following calculation formula:

100×{[(W0×L0)−(W×L)]/(W0×L0)}

wherein the width and length of a gray fabric are defined as W0 and L0, respectively and the width and length of a fabric after shrinking are defined as W and L, respectively.

### (Cleaning Performance)

Next, a glass plate was prepared, and then a given amount of vaseline was applied to the surface of the glass plate. Thereafter, the surface of the glass plate was wiped given times with the obtained cylindrically knitted material. Then, the removal degree of vaseline was observed. Vaseline was thoroughly removed similarly as the samples of Example 6 and Comparative Example 5.

### (Self Particle Generation Properties; Self Particle Generation in Air)

The number of self-generated particles was measured according to IES-RP-CC 003.2 (Helmke drum method) using a particle counter manufactured by RION (KM-27). The number of particles of the sampe of Example 6 was smaller than that of the sample of Comparative Example 5.

### (Self Particle Generation Properties; Self Particle Generation in Liquid)

The number of self-generated particles was measured using a particle counter manufactured by RION (KL-11A). The number of particles of the sample of Example 6 was smaller than that of the sample of Comparative Example 5.

### (Elution Ion)

The amount of ions in a component eluted with ultrapure water was measured by ion chromatography.

### (NVR(IPR))

5 g of wiping cloth was cut out from the obtained wiping cloth to be used as a sample. The sample was extracted (water bath, 95° C.) by 150 ml of isopropyl alcohol for 2 hours using a Soxhlet extractor. The extract was concentrated by a reduced pressure evaporator, and then subjected to evaporation to dryness. Then, the amount of the residue was determined. The sample of Example 6 was 1.06 mg/g and the sample of Comparative Example 5 was 3.89 mg/g. Therefore, the sample of Example 6 has a higher cleaning degree as compared with the sample of Comparative Example 5, and can be suitably used as a wiping cloth in a clean room.

Evaluation results of cleaning performance, self particle generation, elution ion, and NVR (IPR) of Example 6 and Comparative Example 5 are shown in Table 4.

TABLE 4

| | | Ex. 6 | Com. Ex. 5 |
|---|---|---|---|
| Component A | | Nylon 6 + Nylon MXD6 | Nylon 6 |
| | | (containing no titanium | (containing no |
| | | dioxide) | titanium dioxide) |
| Component B | | PET (containing no | Same as in Ex. 6 |
| | | titanium dioxide) | |
| Fiber splitting | | Alkali reduction | Fiber splitting with |
| | | (95° C., 30 minutes) | benzyl alcohol |
| | | | (continuous fiber |
| | | | splitter, 95° C., 2 |
| | | | minutes) |
| Shrinking | | Wet heating at 130° C. | Simultaneously with |
| | | for 30 minutes | fiber splitting |
| Finish density (warp) | | 192 warps/2.54 cm | 192 warps/2.54 cm |
| Finish density (weft) | | 95 wefts/2.54 cm | 95 wefts/2.54 cm |
| Area shrinkage factor | | 35 | 35 |
| (%) | | | |
| Cleaning performance | | Excellent | Excellent |
| Self particle generation | | 18.9 | 31.6 |
| in air (0.3 μm≦) | | | |
| Self particle generation | | 12.0 | 12.3 |
| in liquid (2.0 μm≦) | | | |
| Elution ion | Na⁺ | 0.4 | 0.4 |
| (μg/g) | Ca²⁺ | 3.1 | 7.2 |
| | Cl− | 0.1 | 0.1 |
| | NOX* | 0 | 0.2 |

| | | |
|---|---|---|
| NVR (IPA) (mg/g) | 1.06 | 3.89 |

More specifically, comparison with the sample of Example 6 with the sample of Comparative Example 5 showed that the sample of Example 6 was imparted with a cleaning performance equivalent to that of the sample of Comparative Example 5 which was fiber split by benzyl alcohol using a conventional Nylon 6 as polyimide. Moreover, the number of each of the self-generated particles and the remaining ions was small. Thus, the sample of Example 6 can be suitably used as a wiping cloth for clean rooms.

### INDUSTRIAL APPLICABILITY

The fiber structure using the splittable conjugate fiber of the present invention is suitable for various intended uses, such as clothing (e.g., general clothing, such as a coat and a blouson, and clothing excellent in fashionability and functionality, such as Moisture permeation water proof clothes); and industrial materials, such as various wiping clothes (e.g., an eyeglass wiper, a hard disk wiper, etc.), a filter cloth, a tent, and an air bag for automobiles. Furthermore, since favorable texture can be obtained even if fiber splitting methods other than methods using low-concentration alcohol or alcohol are employed, the present invention is suitable for producing low-cost and environmentally-friendly products.

1-14. (canceled)

15. A splittable conjugate fiber, comprising:
a polyamide resin composition; and
a fiber-forming polymer which does not have an affinity with the polyamide resin composition,
the polyamide resin composition and the fiber-forming polymer being combined with each other in a longitudinal direction of the fiber,
the polyamide resin composition comprising aromatic polyamide and aliphatic polyamide.

16. A splittable conjugate fiber, comprising: a fiber-forming polymer which does not have an affinity with a polyamide resin composition being polyester resin.

17. A splittable conjugate fiber, comprising: a fiber-forming polymer which does not have an affinity with a polyamide resin composition being polyolefin resin.

18. The splittable conjugate fiber according to claim 15, wherein the aromatic polyamide is polyamide containing aliphatic dicarboxylic acid and aromatic diamine as a main structural unit.

19. The splittable conjugate fiber according to claim 15, wherein the aromatic polyamide is poly(metaxylylene adipamide) and the aliphatic polyamide is a Nylon 6 polymer.

20. The splittable conjugate fiber according to claim 19, wherein a weight ratio of the poly(metaxylylene adipamide) and the Nylon 6 polymer is 35:65 to 70:30.

21. The splittable conjugate fiber according to claim 15, comprising no inorganic particles.

22. A fiber structure, comprising the splittable conjugate fiber according to claim 15.

23. The fiber structure according to claim 22, which is a woven material or a knitted material.

24. A wiping cloth, comprising the fiber structure according to claim 22.

25. A method of producing a fiber structure, comprising the steps of:
producing a fiber structure using the splittable conjugate fiber according to claim 15; and
subjecting the fiber structure obtained in the producing step to hot water treatment for fiber splitting the splittable conjugate fiber.

26. A method of producing a fiber structure, comprising the steps of:
producing a fiber structure using the splittable conjugate fiber according to claim 15; and
subjecting the fiber structure obtained in the producing step to alkali dissolution treatment for fiber splitting the splittable conjugate fiber.

27. The method of producing the fiber structure, further comprising a step of heat treating the fiber structure obtained in claim 25.

28. The method of producing the fiber structure, further comprising a step of heat treating the fiber structure obtained in claim 26.

29. A method of producing a wiping cloth, comprising the steps of:
washing the fiber structure obtained by the method according to claim 25 with pure water; and
hermetically sealing a container formed with a resin film containing a resultant.

30. A method of producing a wiping cloth, comprising the steps of:
washing the fiber structure obtained by the method according to claim 26 with pure water; and
hermetically sealing a container formed with a resin film containing a resultant.
